(19) United States
(12) Patent Application Publication
(10) Pub. No.: US 2018/0114502 A1
(43) Pub. Date: Apr. 26, 2018

(54) DISPLAY DEVICE AND DRIVING METHOD FOR CURVED SURFACE DISPLAY

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Rui XU, Beijing (CN); Xiaochuan CHEN, Beijing (CN); Wenqing ZHAO, Beijing (CN); Lei WANG, Beijing (CN)

(21) Appl. No.: 15/526,976

(22) PCT Filed: May 30, 2016
(86) PCT No.: PCT/CN2016/083886

§ 371 Date: May 15, 2017

(30) Foreign Application Priority Data
Mar. 18, 2016 (CN) 201610158931.3

(51) Int. Cl. G09G 3/36; G02F 1/1343; G02F 1/1368

(52) U.S. Cl. CPC G09G 3/3696; G02F 1/134309; G09G 2300/0426; G09G 2320/028; G02F 1/1368

(57) ABSTRACT

A display device and driving method for curved surface display are disclosed The display device includes a flat panel for achieving image display and a controllable liquid crystal cell above the flat panel for achieving curved surface display. The controllable liquid crystal cell includes an upper substrate and a lower substrate, and a liquid crystal layer between the upper substrate and the lower substrate. The lower substrate is an array substrate on which a plurality of driving electrodes for driving liquid crystals in the liquid crystal layer to deflect at different angles are provided. The display device further includes a signal controller for providing voltage signals for the driving electrodes, voltage signals for at least two driving electrodes being different.

### FIELD OF THE INVENTION

The disclosure relates to the field of display technologies, and particularly to a display device and driving method for curved surface display.

### BACKGROUND

Flat panel display devices in the prior art have been widely used because they have the advantage of saving physical space. However, due to their light distribution properties, i.e., the light intensity of a common flat panel display device weakens gradually from the position on the screen surface of the display device right in front of a human eye to both sides of the screen surface, therefore, the human experience in visual angle with the flat panel display devices is not good. This defect is all the more obvious in the case of large sized display devices.

With the curved surface display technology, the display device is made to have a physical curvature or to be curved, so that different positions on the display device all face the human eye directly, in order to achieve optimum visual angle experience. Such bending design, however, makes one feel comfortable only at one central viewing position in the space. This cannot be achieved in other viewing positions. Furthermore, the physical curvature results in a relatively larger space to be occupied by the display device, restricting particularly household application for the curved surface display device.

### SUMMARY

Embodiments of the disclosure provide a display device and a driving method for curved surface display, for achieving a controllable curved surface display effect in the case of a flat panel display device, and saving volume and cost of the curved surface display product.

An embodiment of the disclosure provides a display device which may comprise a flat panel for achieving image display, a controllable liquid crystal cell above the flat panel for achieving curved surface display. The controllable liquid crystal cell may comprise an upper substrate and a lower substrate, and a liquid crystal layer between the upper substrate and the lower substrate. The lower substrate may be an array substrate on which a plurality of driving electrodes for driving the liquid crystals in the liquid crystal layer to deflect at different angles are provided. The display device may further comprise a signal controller for providing voltage signals for the driving electrodes, the voltage signals for at least two driving electrodes being different.

The display device provided by this embodiment of the disclosure comprises a flat panel for achieving image display, a controllable liquid crystal cell above the flat panel for achieving curved surface display. The controllable liquid crystal cell comprises an upper substrate and a lower substrate, and a liquid crystal layer between the upper substrate and the lower substrate. The lower substrate may be an array substrate on which a plurality of driving electrodes for driving the liquid crystals in the liquid crystal layer to deflect at different angles are provided. The display device further comprises a signal controller for providing voltage signals for the driving electrodes. The voltage signals for at least two driving electrodes are different, so that the liquid crystals in the liquid crystal layer deflect at different angles, achieving a curved surface display effect. The user can, therefore, control the voltage signals supplied to the driving electrodes by means of the signal controller as personal requirement such that the liquid crystals at different positions deflect at different angles, so as to adapt the viewing angle of the user in a way similar to adjusting, for example, a single large lens or a plurality of small lens, without having to make the display device into a physically curved surface structure, thereby saving product volume and cost. Meanwhile, the user can control the curved surface display effect of the display device based on to his or her own needs, so the display device is convenient to use.

In some embodiments, the signal controller may include a main control board or an integrated circuit.

In some embodiments, the signal controller may supply voltage signals to the driving electrodes via a flexible printed circuit (FPC) board.

In some embodiments, the driving electrodes may be strip driving electrodes.

In some embodiments, the plurality of driving electrodes may form a driving electrode array.

In some embodiments, each row of driving electrodes in the driving electrode array may comprise a plurality of sets of driving electrodes. Each set of driving electrodes may comprise at least two driving electrodes. All the driving electrodes in each set of driving electrodes are electrically connected to one another. The signal controller may supply different voltage signals to at least two sets of driving electrodes.

In some embodiments, each set of driving electrodes may include two driving electrodes, and the two driving electrodes are arranged symmetrically with respect to the center point of the row in which the set of driving electrodes are located.

In some embodiments, the signal controller provides a different voltage signal to each set of driving electrodes. Thus, a controllable single curved surface display effect for the flat panel display device can be achieved.

In some embodiments, each row of driving electrodes in the driving electrode array may comprise a plurality of sets of first driving electrodes for receiving different voltage signals and a plurality of sets of second driving electrodes for receiving the same voltage signal. The second driving electrodes of the plurality of sets of second driving electrodes are distributed on both sides with the center point of the row of driving electrodes being the center, and adjacent second driving electrodes on each side are spaced by the same number of first driving electrodes. Thus, a controllable multiple curved surface display effect for the flat panel display device can be achieved.

In some embodiments, each row of driving electrodes in the drive electrode array may include m sets of driving electrodes, each set of driving electrodes comprising n driving electrodes. The display device further comprises m electrode signal lines electrically connected with the signal controller for providing the voltage signals. The n driving electrodes in each set of driving electrodes are electrically connected, respectively, to one of the m electrode signal lines via a thin film transistor, both m and n being integers greater than or equal to 2.

In some embodiments, the display device may further comprise a switch signal line electrically connected with the signal controller. The gate of the thin film transistor is electrically connected to the switch signal line. The source and drain of the thin film transistor are electrically connected, respectively, to a corresponding driving electrode and a corresponding electrode signal line.

In some embodiments, the signal controller may output a different voltage signal to each electrode signal line and output a switch signal for controlling the thin film transistor to the switch signal line.

A display device provided according to another embodiment of the present disclosure may comprise a flat panel for achieving image display, the flat panel comprising an array substrate and a color film substrate, a controllable liquid crystal cell above the flat panel for achieving curved surface display, the controllable liquid crystal cell comprising an upper substrate and a lower substrate and a liquid crystal layer between the upper substrate and the lower substrate, the lower substrate being the color film substrate of the flat panel, a plurality of driving electrodes for driving the liquid crystals in the liquid crystal layer to deflect at different angles being arranged on the color film substrate, and a signal controller for providing voltage signals for the driving electrodes, with the voltage signals for at least two driving electrodes being different.

A driving method for curved surface display provided by another embodiment of the disclosure comprises supplying at least two different voltage signals to different driving electrodes of the plurality of driving electrodes in the display device according to any of the preceding embodiments of the disclosure, for driving the liquid crystals in the liquid crystal layer to deflect with at least two different angles.

### BRIEF DESCRIPTION OF THE DRAWINGS

FIG. 1 is a schematic view of the structure of a display device for achieving a curved surface display effect provided by an embodiment of the disclosure,

FIG. 2 is a schematic view of the structure of a controllable liquid crystal cell for achieving curved surface display in a display device for achieving a curved surface display effect provided by an embodiment of the disclosure;

FIG. 3 is a schematic view of driving electrodes provided on an array substrate in a controllable liquid crystal cell for achieving curved surface display provided by an embodiment of the disclosure;

FIG. 4 is a schematic view of the structure of a liquid crystal display device for achieving a curved surface display effect provided by an embodiment of the disclosure;

FIG. 5 is a schematic view of comparison of viewing angles of curved surface display provided by a display device of an embodiment of the disclosure and viewing angles of existing flat panel display;

FIG. 6 is a schematic view of the connection for driving electrodes of a display device provided by an embodiment of the disclosure;

FIG. 7 is a schematic view of the connection for driving electrodes of a display device provided by another embodiment of the disclosure;

FIG. 8 is a schematic view of the connection of the driving electrodes in one row of driving electrodes for single curved surface display provided by an embodiment of the disclosure;

FIG. 9 is a schematic view of the connection of the driving electrodes in one row of driving electrodes for multiple curved surface display provided by an embodiment of the disclosure;

FIG. 10 is a schematic view of the connection between driving electrodes and electrode signal lines for multiple curved surface display provided by another embodiment of the disclosure; and

FIG. 11 is a schematic view of voltage signals to be supplied to the signal lines shown in FIG. 10 provided by an embodiment of the disclosure.

### DETAILED DESCRIPTION OF EMBODIMENTS

Embodiments of the application provide a display device and a driving method for curved surface display, for achieving a controllable curved surface display effect in the case of a flat panel display device, and saving volume and cost of the curved surface display product.

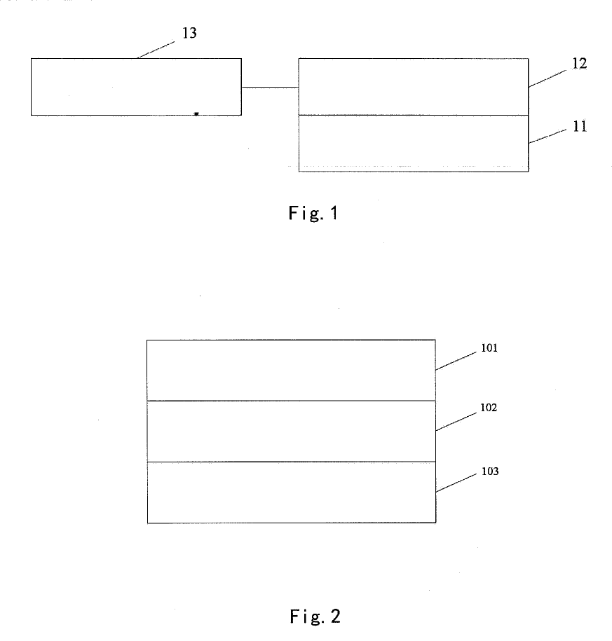

With reference to FIG. 1, a display device provided by an embodiment of the application comprises a flat panel 11 for achieving image display, a controllable liquid crystal cell 12 above the flat panel 11 for achieving curved surface display, and a signal controller 13.

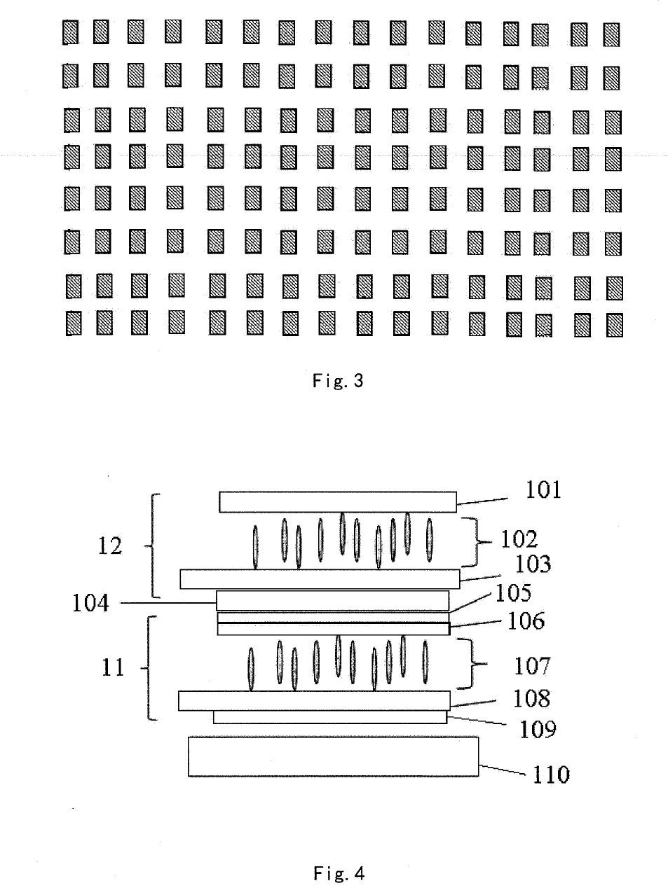

With reference to FIG. 2, the controllable liquid crystal cell 12 may comprise an upper substrate 101 and a lower substrate 103, and a liquid crystal layer 102 between the upper substrate and the lower substrate. The lower substrate 103 may be an array substrate. Referring to FIG. 3, on the array substrate, a plurality of driving electrodes for driving the liquid crystals in the liquid crystal layer 102 to deflect at different angles are provided. For example, a plurality of rows of driving electrodes may be provided on the array substrate, and each row may comprise at least two driving electrodes, whereby the plurality of driving electrodes provided on the array substrate may form a driving electrode array. The signal controller 13 may be used for providing voltage signals for the driving electrodes, and the voltage signals for at least two driving electrodes are different.

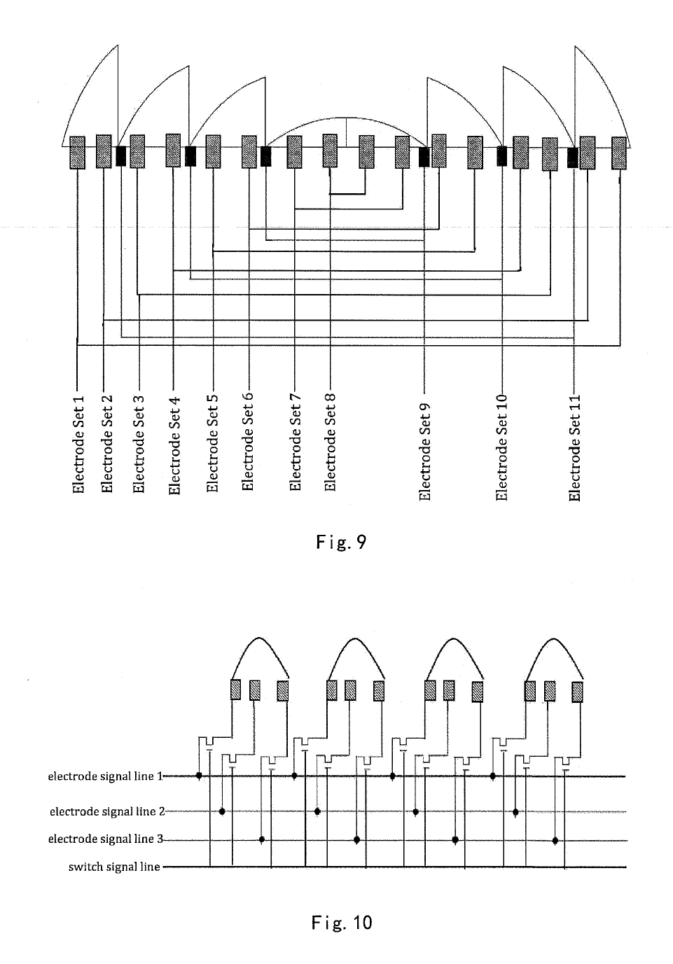

In the embodiment, the display device comprises a flat panel for achieving image display, and a controllable liquid crystal cell above the flat panel for achieving curved surface display. The controllable liquid crystal cell comprises an upper substrate and a lower substrate, and a liquid crystal layer between the upper substrate and the lower substrate. The lower substrate may be an array substrate on which a plurality of driving electrodes for driving the liquid crystals in the liquid crystal layer to deflect at different angles are provided. The display device further comprises a signal controller for providing voltage signals for the driving electrodes. The voltage signals for at least two driving electrodes are different, so that the liquid crystals in the liquid crystal layer deflect at different angles, achieving a curved surface display effect. Therefore, the user can control the voltage signals supplied to the driving electrodes by means of the signal controller as required such that the liquid crystals at different positions deflect at different angles, so as to adapt the viewing angle for the user in a way similar to adjusting a single large lens (e.g., the single curved surface display produced visually as shown in FIG. 8) or a plurality of small lens (e.g., the multiple small curved surface display produced visually as shown in FIG. 9 or 10), without having to make the display device into a physically curved structure, thereby saving product volume and cost. Meanwhile, the user can control the curved surface display effect of the display device according to personal requirement, so the display device is convenient to use.

In an embodiment, the flat panel for achieving image display may be, for example, a liquid crystal display (LCD) panel or an organic light-emitting diode (OLED) display panel. That is, the display device provided by the embodiment of the application may be a liquid crystal display device or an OLED display device.

For the controllable liquid crystal cell for achieving curved surface display according to an embodiment of the application, the refractive index of the liquid crystal can be changed by controlling the voltages of the driving electrodes in the controllable liquid crystal cell, so as to achieve the purpose of bending light. The driving electrodes are provided in the interior of the controllable liquid crystal cell. For example, a plurality of sets of driving electrodes may be provided on the glass of the array substrate, and the plurality of sets of driving electrodes may be connected to the signal controller such as an IC or a main control board by a flexible printed circuit (FPC) board. The signal controller can provide different driving voltages for different driving electrodes respectively, thereby achieving a curved surface display effect and greatly saving product cost and space it occupies.

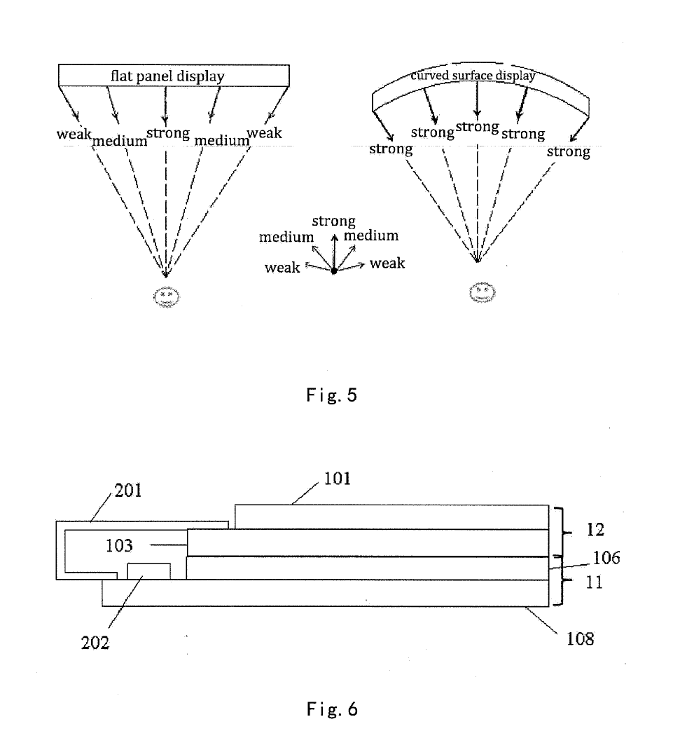

FIG. 4 is a schematic view of the structure of a display device according to an embodiment of the application. In this embodiment, a controllable liquid crystal cell 12 is provided on a LCD panel 11 to achieve curved surface display. The controllable liquid crystal cell 12 comprises an upper substrate 101, a liquid crystal layer 102, and a TFT array substrate 103. The upper substrate may comprise a layer of glass, with an alignment film provided underneath. And the upper electrode 101 may be provided with a common electrode. The controllable liquid crystal cell 12 and the LCD panel 11 may be connected together by OCA (optical clear adhesive). The LCD panel 11 may comprise an upper polarizer 105, a color film substrate 106, a liquid crystal layer 107, a TFT array substrate 108, and a lower polarizer 109. A backlight 110 may be provided below the LCD panel 11. In the embodiment, the controllable liquid crystal cell 12 is implemented in an LCD manner, i.e., making use of the arrangement of the driving electrodes in the liquid crystal cell, and changing the refractive index of the liquid crystal by changing the driving voltages supplied to the driving electrodes, to achieve the purpose of bending light. In this way, as shown in FIG. 5, the light intensity of the existing flat panel display device weakens gradually from the position right in front of the human eye to both sides, and the viewing angles for human's eye for other positions on the flat panel display device are not good. However, with the display device shown in FIG. 4, it is possible to correct the viewing angles by means of the controllable liquid crystal cell 12 to achieve a curved surface display effect.

An electrode driving solution for achieving curved surface display provided according to an embodiment of the application will be described below, taking a display device comprising a controllable liquid crystal cell and an LCD panel as an example.

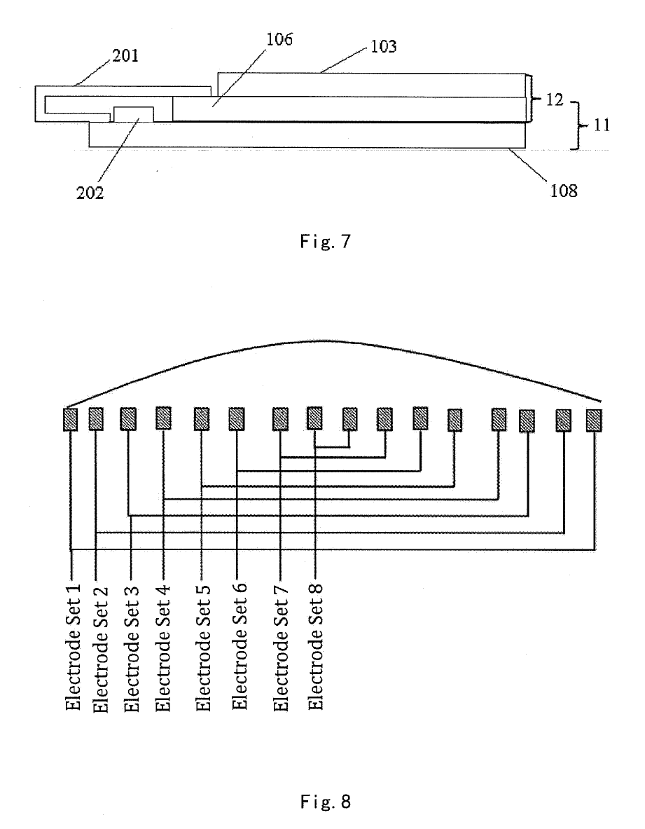

By controlling the deflection of the liquid crystals with a limited number of driving electrodes in the controllable liquid crystal cell, it is possible to achieve a single curved surface or multiple curved surface display effect. Each row of driving electrodes may comprise several sets of driving electrodes. These driving electrodes for producing curved surface display may be provided on the lower layer glass (i.e., TFT array substrate) of the controllable liquid crystal cell, and bonded to the lower layer glass of the controllable liquid crystal cell by a film material of flexible printed circuit (FPC) board 201, and finally connected to the flat panel for achieving image display together with the controllable liquid crystal cell by means of connecting lines, as shown in FIGS. 6 and 7. FIGS. 6 and 7 schematically show display device structures for achieving curved surface display according to two different embodiments. For the sake of brevity, FIGS. 6 and 7 do not show the liquid crystal layer in the controllable liquid crystal cell and in the LCD panel. As shown in FIG. 6, the controllable liquid crystal cell 12 and the LCD panel 11 are two separate structures. The driving electrodes (not shown in FIG. 6) may be bonded to a lower substrate 103 of the controllable liquid crystal cell by a film material of flexible printed circuit (FPC) board 201, and connected to the LCD panel 11 for achieving image display together with the controllable liquid crystal cell 12 by means of connecting lines. As shown in FIG. 7, the display device provided by a further embodiment of the present disclosure may comprise a flat panel 11 for achieving image display which comprises an array substrate 108 and a color film substrate 106, and a controllable liquid crystal cell 12 above the flat panel 11 for achieving curved surface display. The controllable liquid crystal cell 12 may comprise an upper substrate 103 and a lower substrate, and a liquid crystal layer (not shown) between the upper substrate 103 and the lower substrate. The lower substrate 106 may be the color film substrate 106 of the flat panel 11. On the color film substrate 106, a plurality of driving electrodes for driving the liquid crystals in the liquid crystal layer to deflect at different angles are provided. The display device further comprises a signal controller 202 for providing voltage signals for the driving electrodes, with the voltage signals for at least two driving electrodes being different. Thus, in this embodiment, the controllable liquid crystal cell 12 and the LCD panel 11 share a substrate, i.e., the color film substrate 106 of the flat panel (e.g., LCD panel) 11. That is, the color film substrate of the controllable liquid crystal cell 12 may be omitted to simplify the structure of the display device.

In the embodiments shown in FIGS. 6 and 7, the driving electrodes provided in the controllable liquid crystal cell 12 can be connected to the array substrate 108 of the LCD panel 11 by means of the flexible printed circuit board 201 may, and the array substrate 108 of the LCD panel 11 may be connected to an IC 202 or a system main control board (not shown). That is, in these embodiments, the driving electrodes in the controllable liquid crystal cell are bonded to a glass substrate of the controllable liquid crystal cell by a material of a flexible printed circuit board, and finally connected to the flat panel for achieving image display together with the controllable liquid crystal cell by means of connecting lines.

In the case of one viewer, the human eye may face directly the center of the entire screen, and have the best viewing angle. In this case, the viewer may be provided with a curved surface display effect including a single curved surface. In this embodiment, an example of the configuration of the driving electrodes in each row may be as shown in FIG. 8. The center point of the row of driving electrodes is taken as the center, and the driving electrodes on both sides of the center point are connected together in pairs. For example, the row of driving electrodes may be divided into eight sets, namely, Electrode Set 1, Electrode Set 2, Electrode Set 3, Electrode Set 4, Electrode Set 5, Electrode Set 6, Electrode Set 7, and Electrode Set 8. In the example shown in FIG. 8, each electrode set comprises two driving electrodes. The display system (e.g., the signal controller, such as a main control board or IC) may provide different signals for the eight electrode sets through a FPC respectively, i.e., the driving voltages for Electrode Set 1, Electrode Set 2, Electrode Set 3, Electrode Set 4, Electrode Set 5, Electrode Set 6, Electrode Set 7 and Electrode Set 8 may be different from one another, so that the liquid crystals in the controllable liquid crystal cell may be driven to deflect at different angles to achieve the single curved surface display effect shown in FIG. 8.

In the case of multiple viewers, a display effect including a plurality of curved surfaces may be needed. Therefore, the deflection angles of the liquid crystals at different positions in the controllable liquid crystal cell of the display device may be adjusted according to the positions of the plurality of viewers. In this case, an example of the configuration of the driving electrodes in each row may be as shown in FIG. 9. The center point of a row of driving electrodes is taken as the center, and the driving electrodes which are symmetric with respect to the center point are connected together in pairs, thereby obtaining Electrode Set 1, Electrode Set 2, Electrode Set 3, Electrode Set 4, Electrode Set 5, Electrode Set 6, Electrode Set 7, Electrode Set 8, Electrode Set 9, Electrode Set 10 and Electrode Set 11. In some embodiments, as shown in FIG. 9, each row of driving electrodes may comprise a plurality of sets of first driving electrodes for receiving different voltage signals, for example Electrode Sets 1 to 8, and a plurality of sets of second driving electrodes for receiving the same voltage signal, for example Electrode Sets 9 to 11 shown by dark blocks in FIG. 9. The second driving electrodes of the plurality of sets 9, 10, 11 of second driving electrodes are distributed on both sides with the center point of the row of driving electrodes being the center, and adjacent second driving electrodes on each side are spaced by the same number of first driving electrodes. In other words, in the example of FIG. 9, Electrode Sets 1 to 8 to which different driving voltages are supplied to generate different curvatures are referred to as sets of first driving electrodes, and Electrode Sets 9 to 11 to which the same voltage signal is supplied are referred to as sets of second driving electrodes. In this example, the voltage signals supplied to Electrode Sets 1 to 8 may be higher than the voltage signals for Electrode Sets 9 to 11, so as to achieve a liquid crystal electric field similar to a prism after the liquid crystals are deflected under the control of the voltage signals of the driving electrodes, thereby achieving a curved surface display effect suitable for multiple viewers. For example, as shown in FIG. 9, it is possible to produce a multiple curved surface display effect with three curved surfaces on the left, three curved surfaces on the right, and one curved surface in the middle. More driving electrodes may need to be arranged when it is desired to achieve a display effect including much more curved surfaces (i.e., to achieve multiple curved surface display) or to achieve a stereoscopic display effect. In another embodiment, each row of driving electrodes comprises m sets of driving electrodes, each set of driving electrodes comprising n driving electrodes. The display device may further comprise m electrode signal lines electrically connected with the signal controller to supply voltage signals. The n driving electrodes in each set of driving electrodes are electrically connected, respectively, to one of the in electrode signal lines via a thin film transistor, m and n being integers greater than or equal to two. For example, as shown in FIG. 10, each row of driving electrodes may comprise three sets of driving electrodes. In FIG. 10, the four driving electrodes electrically connected with electrode signal line 1 may be referred to as the first set of driving electrodes, the four driving electrodes electrically connected with electrode signal line 2 may be referred to as the second set of driving electrodes, and the four driving electrodes electrically connected with electrode signal line 3 may be referred to as the third set of driving electrodes. Each set of driving electrodes comprises four driving electrodes. The display device further comprises three electrode signal lines electrically connected with the signal controller for supplying voltage signals. The four driving electrodes in each set of driving electrodes are electrically connected, respectively, to one electrode signal line via a thin film transistor. In the embodiment, as shown in FIG. 10, the display device further comprises a switch signal line electrically connected with the signal controller. The gate of the thin film transistor is electrically connected to the switch signal line, and the source and drain of the thin film transistor are electrically connected, respectively, to a driving electrode and an electrode signal line. Therefore, in the embodiment, only four signal lines are required to achieve driving of the liquid crystals by three sets of driving electrodes including 12 driving electrodes, thereby saving space of the substrate on which the driving electrodes are provided. Also, in the embodiment, a display effect with a plurality of substantially identical small curved surfaces can be produced visually.

In some embodiments, the signal controller may provide different voltage signals to the electrode signal lines and output a switch signal for controlling the thin film transistor to the switch signal line, so as to produce different curved surface display effects.

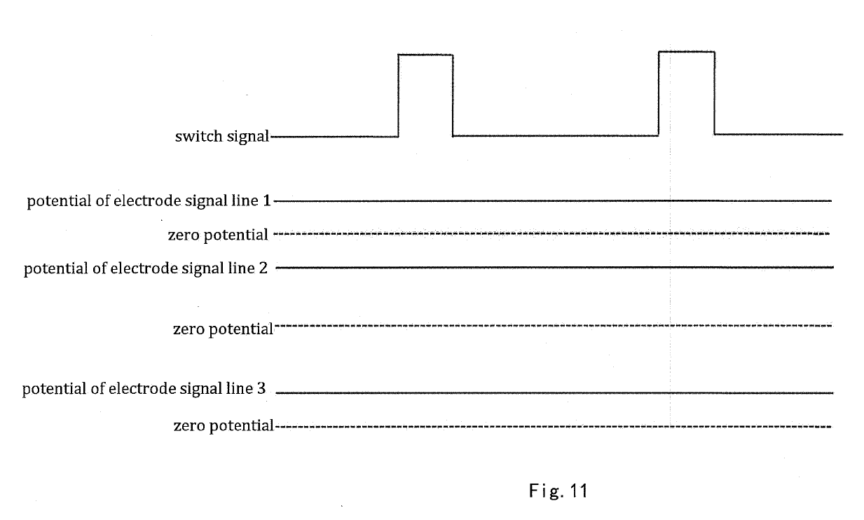

Alternatively, the same voltage signal may be supplied to some of the electrode signal lines. For example, as shown in FIG. 11, the voltage of the electrode signal line 2 is higher than the voltage of the electrode signal line 1 and the electrode signal line 3. The voltages of the electrode signal lines 1 and the electrode signal lines 3 may be equal. In this way, a display effect with a plurality of substantially identical small curved surfaces as shown in FIG. 10 can be produced visually.

The above embodiments of the disclosure provide a means for achieving curved surface display on a flat panel for achieving image display, thereby achieving a curved surface display effect using a flat panel display device. In some embodiments, driving electrodes may be provided in the plane of the array substrate of the controllable liquid crystal cell, and voltage signals may be supplied to the driving electrodes through electrode signal lines. By controlling the magnitude of the voltage signals supplied to the driving electrodes, the viewing angle can be adapted in a way similar to adjusting, for example, a single large lens or a plurality of small lens.

Another embodiment of the disclosure provides a driving method for curved surface display, which may comprise supplying at least two different voltage signals to different driving electrodes of a plurality of driving electrodes in the display device according to any of the preceding embodiments herein, for driving the liquid crystals in the liquid crystal layer to deflect with at least two different angles. The driving method may be implemented by such devices as main control board or IC. Controlling the magnitude of the voltage signals of the driving electrodes in the display device with such a driving method can achieve adjustment to the viewing angle in a way similar to adjusting, for example, a single large lens or a plurality of small lens.

It is apparent that various changes and modifications may be made to the present disclosure by a person having an ordinary skill in the art without departing from the spirit and scope of the invention. Thus, if these changes and modifications to the disclosure are within the scope of the appended claims and the equivalents thereof, it is the intent that the invention encompasses these changes and modifications as well.

1. A display device comprising:
a flat panel for achieving image display,
a controllable liquid crystal cell above the flat panel for achieving curved surface display, the controllable liquid crystal cell comprising an upper substrate and a lower substrate, and a liquid crystal layer between the upper substrate and the lower substrate, the lower substrate being an array substrate on which a plurality of driving electrodes for driving liquid crystals in the liquid crystal layer to deflect at different angles are provided, and
a signal controller for providing voltage signals for the driving electrodes, voltage signals for at least two driving electrodes being different.

2. The display device according to claim 1, wherein the signal controller comprises a main control board or an integrated circuit.

3. The display device according to claim 1, wherein the signal controller supplies voltage signals to the driving electrodes through a flexible printed circuit board.

4. The display device according to claim 1, wherein the driving electrodes are strip driving electrodes.

5. The display device according to claim 1, wherein the plurality of driving electrodes form a driving electrode array.

6. The display device according to claim 5, wherein each row of driving electrodes in the driving electrode array comprises a plurality of sets of driving electrodes, each set of driving electrodes comprising at least two driving electrodes, all the driving electrodes in each set of driving electrodes being electrically connected to one another, wherein the signal controller supplies different voltage signals to at least two sets of driving electrodes.

7. The display device according to claim 6, wherein each set of driving electrodes comprises two driving electrodes, and the two driving electrodes are arranged symmetrically with respect to a center point of the row in which the set of driving electrodes is located.

8. The display device according to claim 7, wherein the signal controller provides a different voltage signal to each set of driving electrodes.

9. The display device according to claim 7, wherein each row of driving electrodes in the driving electrode array comprises a plurality of sets of first driving electrodes for receiving different voltage signals and a plurality of sets of second driving electrodes for receiving the same voltage signal, wherein the second driving electrodes of the plurality of sets of second driving electrodes are distributed on both sides with the center point of the row of driving electrodes being a center, and adjacent second driving electrodes on each side are spaced by a same number of first driving electrodes.

10. The display device according to claim 5, wherein each row of driving electrodes in the drive electrode array comprises in sets of driving electrodes, each set of driving electrodes comprising n driving electrodes, wherein the display device further comprises m electrode signal lines electrically connected with the signal controller for providing the voltage signals, the n driving electrodes in each set of driving electrodes being electrically connected respectively to one of the in electrode signal lines via a thin film transistor, both m and n being integers greater than or equal to 2.

11. The display device according to claim 10, wherein the display device further comprises a switch signal line electrically connected with the signal controller, a gate of the thin film transistor being electrically connected to the switch signal line, a source and a drain of the thin film transistor being electrically connected respectively to a driving electrode and an electrode signal line.

12. The display device according to claim 11, wherein the signal controller provides a different voltage signal to each electrode signal line and outputs a switch signal for controlling the thin film transistor to the switch signal line.

13. A display device comprising:
a flat panel for achieving image display, the flat panel comprising an array substrate and a color film substrate,
a controllable liquid crystal cell above the flat panel for achieving curved surface display, the controllable liquid crystal cell comprising an upper substrate and a lower substrate, and a liquid crystal layer between the upper substrate and the lower substrate, the lower substrate being the color film substrate of the flat panel, a plurality of driving electrodes for driving liquid crystals in the liquid crystal layer to deflect at different angles being arranged on the color film substrate, and
a signal controller for providing voltage signals for the driving electrodes, voltage signals for at least two driving electrodes being different.

14. A driving method for curved surface display comprising: supplying at least two different voltage signals to different driving electrodes of the plurality of driving electrodes in the display device according to claim 1, for driving liquid crystals in the liquid crystal layer to deflect with at least two different angles.

15. The driving method according to claim 14, wherein the plurality of driving electrodes form a driving electrode array.

16. The driving method according to claim 15, wherein each row of driving electrodes in the driving electrode array comprises a plurality of sets of driving electrodes, each set of driving electrodes comprising at least two driving electrodes, all the driving electrodes in each set of driving electrodes being electrically connected to one another, wherein the signal controller supplies different voltage signals to at least two sets of driving electrodes.

17. The driving method according to claim 16, wherein each set of driving electrodes comprises two driving electrodes, and the two driving electrodes are arranged symmetrically with respect to a center point of the row in which the set of driving electrodes is located.

18. The driving method according to claim 17, wherein the signal controller provides a different voltage signal to each set of driving electrodes.

19. The driving method according to claim 17, wherein each row of driving electrodes in the driving electrode array comprises a plurality of sets of first driving electrodes for receiving different voltage signals and a plurality of sets of second driving electrodes for receiving the same voltage signal, wherein the second driving electrodes of the plurality of sets of second driving electrodes are distributed on both sides with the center point of the row of driving electrodes being a center, and adjacent second driving electrodes on each side are spaced by a same number of first driving electrodes.

20. The driving method according to claim 15, wherein each row of driving electrodes in the drive electrode array comprises m sets of driving electrodes, each set of driving electrodes comprising n driving electrodes, wherein the display device further comprises m electrode signal lines electrically connected with the signal controller for providing the voltage signals, the n driving electrodes in each set of driving electrodes being electrically connected respectively to one of the m electrode signal lines via a thin film transistor, both m and n being integers greater than or equal to 2.
